(19) United States
(12) Patent Application Publication
(10) Pub. No.: US 2026/0264504 A1
(43) Pub. Date: Sep. 10, 2026

(54) POWERTRAIN ASSEMBLY FOR ELECTRIC VEHICLE

(71) Applicant: ZF Friedrichshafen AG, Friedrichshafen (DE)

(72) Inventors: Qing Xu, Shanghai (CN); Shaozhi Yuan, Shanghai (CN)

(73) Assignee: ZF Friedrichshafen AG, Friedrichshafen (DE)

(21) Appl. No.: 19/557,888

(22) Filed: Mar. 5, 2026

(30) Foreign Application Priority Data
Mar. 5, 2025 (CN) 202510256000.6

(51) Int. Cl. B60K 6/442; B60K 6/26; B60K 6/387; B60K 17/16

(52) U.S. Cl. CPC B60K 6/442; B60K 6/26; B60K 6/387; B60K 17/16

(57) ABSTRACT

A powertrain assembly for an electric vehicle includes an engine, a first electric motor, a second electric motor and a transmission device, the engine being connected to the first electric motor via part of members of the transmission device to form a first powertrain, and the second electric motor being connected to a differential mechanism of the transmission device. The powertrain assembly further includes a controller shared by the first and second electric motors, the controller being configured to manage energy conversion of the first and second electric motors such that the first powertrain and/or the second electric motor operates in a specified operating mode. The first and second electric motors share a single controller for energy conversion management, so that the powertrain assembly has a simple overall structure, thereby facilitating an integrated and lightweight design.

### CROSS-REFERENCE TO RELATED APPLICATION

This application claims priority to Chinese Patent Application No. 202510256000.6, filed on Mar. 5, 2025, the entirety of which is hereby fully incorporated by reference herein.

### TECHNICAL FIELD

The present disclosure relates to the technical field of electric vehicles and, in particular, to a powertrain assembly for an electric vehicle.

### BACKGROUND

For electric vehicles provided with a first electric motor and a second electric motor, a separate controller is provided for each of the first electric motor and the second electric motor in the prior art, for example, a rectifier and an inverter are provided for each of the first electric motor and the second electric motor, resulting in a complex powertrain structure with numerous parts and components, thereby hindering integration and lightweight design.

It should be noted that information disclosed in the above background art section is only used to enhance the understanding of the background of the present disclosure, and therefore may include information that does not constitute the prior art known to those of ordinary skill in the art.

### SUMMARY

The present disclosure provides a powertrain assembly for an electric vehicle, the powertrain assembly having a simple overall structure, thereby facilitating an integrated and lightweight design.

According to one aspect of the present disclosure, provided is a powertrain assembly for an electric vehicle, the powertrain assembly including an engine, a first electric motor, a second electric motor and a transmission device, the engine being connected to the first electric motor via part of members of the transmission device to form a first powertrain, and the second electric motor being connected to a differential mechanism of the transmission device. The powertrain assembly further includes a controller shared by the first electric motor and the second electric motor, the controller being configured to manage energy conversion of the first electric motor and the second electric motor such that the first powertrain and/or the second electric motor operates in a specified operating mode.

In some embodiments, the controller integrates two inverter modules which are respectively connected to the first electric motor and the second electric motor.

In some embodiments, each of the inverter modules includes an inverter circuit and a drive circuit which are electrically connected to each other, the two inverter circuits being integrated on a power board of the controller, and the two drive circuits being integrated on a control board of the controller.

In some embodiments, the power board and/or the control board is formed as a chip-embedded circuit board.

In some embodiments, the control board and the power board are assembled via a frame board and are electrically connected via a signal pin, where the signal pin passes through the frame board, and two ends of the signal pin are respectively electrically connected to the power board and the control board.

In some embodiments, the controller is further provided with a heat dissipation module which acts on at least the two inverter modules.

In some embodiments, the controller is further provided with a capacitor shared by the two inverter modules.

In some embodiments, the capacitor is integrally potted with an enclosure of the controller, or the capacitor is packaged by a housing separate from the enclosure of the controller.

In some embodiments, there is no mechanical coupling between the first powertrain and the second electric motor, and the first powertrain is configured for electricity generation.

In some embodiments, there is a mechanical coupling between the first powertrain and the second electric motor, and the first powertrain is configured for electricity generation and driving.

In some embodiments, a coupling component of the transmission device for coupling the first powertrain with the second electric motor includes: a transmission gear including a first toothed member connected to the first powertrain and a second toothed member connected to the second electric motor; and a clutch connected between the engine and the first toothed member.

In some embodiments, the clutch is a single clutch having two members respectively connected the engine and the first toothed member, the two members of the single clutch being engageable with or disengageable from each other.

In some embodiments, the clutch is a dual clutch having a first member connected to the engine, a second member connected to the first electric motor, and a third member connected to the first toothed member; and the first member and the third member are each engageable with or disengageable from the second member, and the first member is engageable with or disengageable from the third member.

In some embodiments, the transmission device further includes: a planetary gear shift mechanism connected between the second toothed member and the differential mechanism.

In some embodiments, the planetary gear shift mechanism includes: a planetary gear mechanism including three transmission elements, where a first transmission element is connected to the second toothed member, and a second transmission element is connected to the differential mechanism; and a synchronizer configured to fix the second transmission element to a third transmission element of the planetary gear mechanism, to free all three transmission elements, or to fix the third transmission element.

In some embodiments, the transmission device further includes: a disengagement mechanism disposed on an output shaft of the differential mechanism.

In some embodiments, a transmission member connected between the engine and the first electric motor includes a torsional damper and/or a planetary speed increaser.

In some embodiments, when the transmission member includes the torsional damper and the planetary speed increaser and a coupling component is provided between the first powertrain and the second electric motor, the coupling component is connected between the torsional damper and the planetary speed increaser.

In some embodiments, the differential mechanism includes: a gear set connected to the second electric motor; and a differential connected to the gear set.

In some embodiments, the differential mechanism includes two differential planetary gear sets forming a coaxial planetary speed reducer integrated with a differential.

In some embodiments, the powertrain assembly is operable in any of the following operating modes: the first powertrain operating in an electricity generation mode when the engine drives the first electric motor by the transmission device; a first driving mode in which the engine operates when the engine drives the differential mechanism by the transmission device; a second driving mode in which the first electric motor operates when the first electric motor drives the differential mechanism by the transmission device; an operating mode in which the electricity generation mode is executed simultaneously with the first driving mode; an operating mode in which the first driving mode is executed simultaneously with the second driving mode; a third driving mode in which the second electric motor operates when the second electric motor drives the differential mechanism; an operating mode in which the third driving mode is executed simultaneously with the electricity generation mode; an operating mode in which the third driving mode is executed simultaneously with the first driving mode; an operating mode in which the third driving mode is executed simultaneously with the second driving mode; an operating mode in which the third driving mode is executed simultaneously with the electricity generation mode and the first driving mode; an operating mode in which the third driving mode is executed simultaneously with the first driving mode and the second driving mode; a first energy recovery mode in which the second electric motor operates when the second electric motor recovers energy; an operating mode in which the first energy recovery mode is executed simultaneously with the electricity generation mode; a second energy recovery mode in which the first electric motor and the second electric motor operate when the first electric motor and the second electric motor collectively recover energy; and an operating mode in which the second energy recovery mode is executed simultaneously with the electricity generation mode.

Compared with the prior art, the present disclosure has at least the following beneficial effects.

The first electric motor and the second electric motor share a single controller for energy conversion management, eliminating the need for separate controllers for the first electric motor and the second electric motor, so that the powertrain assembly has a simple overall structure, thereby facilitating an integrated and lightweight design.

In the powertrain assembly, the controller manages the energy conversion of the first electric motor such that the first powertrain can operate in an electricity generation mode and/or a driving mode; and the controller manages the energy conversion of the second electric motor such that the second electric motor can operate in a driving mode. The energy conversion of the first electric motor and the second electric motor is managed by the controller such that the first powertrain and/or the second electric motor operates in a specified operating mode to meet the requirements of various operating conditions of the electric vehicle.

It should be understood that the above general description and the following detailed description are only exemplary and explanatory, and cannot limit the present disclosure.

### BRIEF DESCRIPTION OF THE DRAWINGS

The accompanying drawings herein, which are incorporated into and form a part of the description, illustrate embodiments consistent with the present disclosure and, together with the description, are used to explain principles of the present disclosure. Obviously, the accompanying drawings described below show merely some of the embodiments of the present disclosure, and those of ordinary skill in the art would also have obtained other accompanying drawings according to these accompanying drawings without any creative effort.

FIG. 1 shows a schematic diagram of modules of a powertrain assembly according to various embodiments of the present disclosure;

FIG. 2 shows a schematic structural diagram of a controller according to various embodiments of the present disclosure;

FIGS. 3 and 4 show schematic structural diagrams of the powertrain assembly without any mechanical coupling between a first powertrain and a second electric motor according to various embodiments of the present disclosure; and

FIGS. 5, 6 and 7 show schematic structural diagrams of the powertrain assembly with a mechanical coupling between the first powertrain and the second electric motor according to various embodiments of the present disclosure.

### DETAILED DESCRIPTION

Now exemplary implementations will be described more fully with reference to the accompanying drawings. However, the exemplary implementations can be implemented in many forms and should not be construed as being limited to the implementations described herein. On the contrary, these implementations are provided to make the present disclosure more thorough and complete, and to fully convey the concept of the exemplary implementations to those skilled in the art.

The accompanying drawings are only schematic illustrations of the present disclosure, and are not necessarily drawn to scale. In the accompanying drawings, the same reference numerals denote the same or similar parts, and thus the repeated description thereof will be omitted. Some block diagrams shown in the accompanying drawings are functional entities, which do not necessarily correspond to physically or logically independent entities. These functional entities may be implemented in the form of software, in one or more hardware modules or integrated circuits, or in different networks and/or processor apparatuses and/or micro-controller apparatuses.

The processes shown in the accompanying drawings are only exemplary illustrations, and do not necessarily include all steps. For example, some steps can be divided, and some steps can be combined or partially combined, and the actual execution order thereof may be changed based on actual conditions. The terms “first”, “second” and similar terms used in the specific description do not denote any order, quantity, or importance, but are merely used to distinguish between different components. In addition, in the description of the present disclosure, the terms “connect” should be interpreted in a broad sense unless explicitly defined and limited otherwise, which, for example, may be a fixed connection, a detachable connection or an integral connection; may be a mechanical connection or an electrical connection; or may be a direct connection, an indirect connection by an intermediary, or internal communication between two elements.

It should be noted that the embodiments in the disclosure and features of the various embodiments can be combined with each other without conflict.

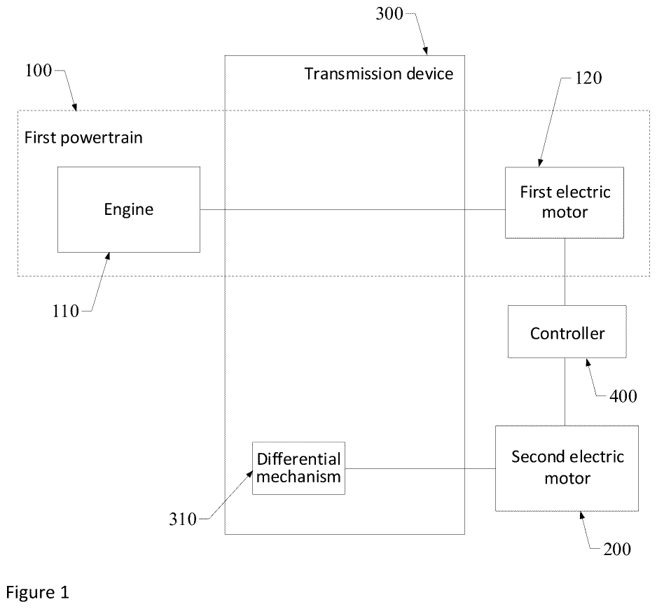

FIG. 1 illustrates main modules of a powertrain assembly. Referring to FIG. 1, an embodiment of the present disclosure provides a powertrain assembly for an electric vehicle. The powertrain assembly includes:
an engine 110, a first electric motor 120, a second electric motor 200, and a transmission device 300. The engine 110 is connected to the first electric motor 120 by part of members of the transmission device 300 to form a first powertrain 100, and the second electric motor 200 is connected to a differential mechanism 310 of the transmission device 300.

The powertrain assembly includes a controller 400. The first electric motor 120 and the second electric motor 200 share the controller 400, and the controller 400 is configured to manage energy conversion of the first electric motor 120 and the second electric motor 200 such that the first powertrain 100 and/or the second electric motor 200 operates in a specified operating mode.

The first electric motor 120 and the second electric motor 200 share a single controller 400 for energy conversion management, eliminating the need for separate controllers for the first electric motor 120 and the second electric motor 200, so that the powertrain assembly has a simple overall structure, thereby facilitating an integrated and lightweight design.

In the powertrain assembly, the engine 110 is connected to the first electric motor 120 to form the first powertrain 100, and the controller 400 manages the energy conversion of the first electric motor 120 such that the first powertrain 100 can operate in an electricity generation mode and/or a driving mode. In the electricity generation mode, the engine 110 drives the first electric motor 120 to operate, and the controller 400 converts electrical energy output from the first electric motor 120 into direct current before it is stored to a battery of the electric vehicle. In a first driving mode, the engine 110 transmits power through the transmission device 300 to the differential mechanism 310 to drive wheels of the electric vehicle. In a second driving mode, the controller 400 converts electrical energy output from the battery into alternating current to drive the first electric motor 120 to operate, and the first electric motor 120 transmits power through the transmission device 300 to the differential mechanism 310 to drive the wheels. The electricity generation mode, the first driving mode, the second driving mode may each be executed independently, the electricity generation mode and the first driving mode may be executed simultaneously, or the first driving mode and the second driving mode may be executed simultaneously, depending on the power distribution strategy of the electric vehicle. In most operating conditions, the first electric motor 120 is configured for electricity generation. In certain operating conditions, in conjunction with the structural design of the transmission device 300, the first powertrain 100 may be configured for driving to increase vehicle power.

In the powertrain assembly, the controller 400 manages the energy conversion of the second electric motor 200 such that the second electric motor 200 can operate in a driving mode. Specifically, the second electric motor 200 may operate in a third driving mode, in which the controller 400 converts the electrical energy output from the battery into alternating current to drive the second electric motor 200 to operate, and the second electric motor 200 transmits power to the differential mechanism 310 to drive the wheels. The second electric motor 200 may also perform energy recovery, that is, operating in a first energy recovery mode. In addition, in conjunction with the structural design of the transmission device 300, the first electric motor 120 may also be involved in energy recovery, that is, the first electric motor 120 and the second electric motor 200 collectively operate in a second energy recovery mode. Depending on the power distribution strategy of the electric vehicle, The third driving mode, the first energy recovery mode, the second energy recovery mode may each operate independently, the third driving mode may be operated simultaneously with any one of the electricity generation mode, the first driving mode and the second driving mode, the third driving mode may be operated simultaneously with the electricity generation mode and the first driving mode, the third driving mode may be operated simultaneously with the first driving mode and the second driving mode, or the first energy recovery mode or the second energy recovery mode may be executed simultaneously with the electricity generation mode.

The controller 400 may communicate with an electronic control unit (ECU) of the electric vehicle, and the power distribution strategy between the engine 110, the first electric motor 120 and the second electric motor 200 may be determined by the electronic control unit. The controller 400 is configured to manage the energy conversion of the first electric motor 120 and the second electric motor 200 according to the received power distribution strategy, such that the first powertrain 100 and/or the second electric motor 200 operates in a specified operating mode to meet the requirements of various operating conditions of the electric vehicle. In the present disclosure, the energy conversion of the first electric motor 120 and the second electric motor 200 is managed based on a specified power distribution strategy through the integrated design of the controller 400. Furthermore, in the present disclosure, the powertrain assembly can implement different operating modes based on a specified power distribution strategy through the structural design of the transmission device 300.

In some embodiments, the controller 400 integrates two inverter modules which are respectively connected to the first electric motor 120 and the second electric motor 200. The independent management of the energy conversion of the first electric motor 120 and the second electric motor 200 is facilitated by virtue of the two inverter modules.

When the first electric motor 120 operates in the electricity generation mode or in the second energy recovery mode, the inverter module connected to the first electric motor 120 functions as a rectifier. When the first electric motor 120 operates in the second driving mode, the inverter module connected to the first electric motor 120 functions as an inverter. When the second electric motor 200 operates in the third driving mode, the inverter module connected to the second electric motor 200 functions as an inverter. When the second electric motor 200 operates in the first energy recovery mode or in the second energy recovery mode, the inverter module connected to the second electric motor 200 functions as a rectifier.

In an embodiment of the present disclosure, the first electric motor 120 is, for example, a permanent magnet synchronous motor (PSM), and the second electric motor 200 is, for example, an asynchronous motor (ASM), but the present disclosure is not limited thereto.

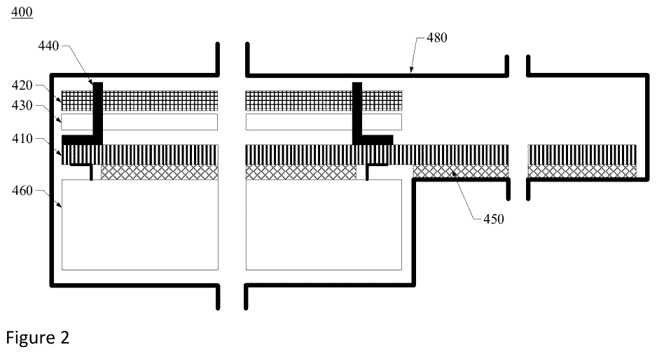

FIG. 2 illustrates the structure of the controller. As shown in FIGS. 1 and 2, in some embodiments, each inverter module of the controller 400 includes an inverter circuit and a drive circuit which are electrically connected to each other. The two inverter circuits are integrated on a power board 410 of the controller 400, and the two drive circuits are integrated on a control board 420 of the controller 400. The circuit structures and principles of the inverter circuit and the drive circuit are already known and are not specifically shown in FIG. 2. In the present disclosure, by integrating two inverter circuits on the power board 410 and integrating two drive circuits on the control board 420, two inverter modules integrated on the same controller 400 are formed, thereby enabling the controller 400 to manage the energy conversion of the first electric motor 120 and the second electric motor 200 based on the two inverter modules.

In some embodiments, the power board 410 and/or the control board 420 is formed as a chip-embedded circuit board. The chip-embedded circuit board is a circuit board in which a chip is embedded to implement a power board 410/control board with high integration and high reliability.

Still as shown in FIGS. 1 and 2, in some embodiments, the control board 420 and the power board 410 are assembled via a frame board 430 and are electrically connected via a signal pin 440. The signal pin 440 passes through the frame board 430, and two ends of the signal pin 440 are respectively electrically connected to the power board 410 and the control board 420.

The frame board 430 is configured to support and assemble the control board 420 and the power board 410, and the three may be fixed by snap-fit, screwing, etc. The electrical connection between the signal pin 440 and the power board 410 and the control board 420 may be achieved by soldering.

Still as shown in FIGS. 1 and 2, in some embodiments, the controller 400 is further provided with a heat dissipation module 450 which acts on at least the two inverter modules. The heat dissipation module 450 may be located on a side of the power board 410 facing away from the control board 420, and has an effective heat dissipation area covering at least the two inverter modules.

Still as shown in FIGS. 1 and 2, in some embodiments, the controller 400 is further provided with a capacitor 460. The two inverter modules share the capacitor 460. The capacitor 460 is specifically a direct-current link capacitor (DC-Link capacitor). The capacitor 460 may be disposed on a side of the heat dissipation module 450 facing away from the power board 410 to achieve heat dissipation while optimizing the layout of the internal structure of the controller 400. The two inverter modules sharing the capacitor 460 can reduce the number of components of the controller 400 and facilitate the miniaturized design of the controller 400.

In some embodiments, the capacitor 460 is integrally potted with an enclosure 480 of the controller 400, so that the cost of a housing of the capacitor 460 can be saved. Alternatively, the capacitor 460 may be packaged by a housing separate from the enclosure 480 of the controller 400.

In some embodiments, there is no mechanical coupling between the first powertrain 100 and the second electric motor 200, the first powertrain 100 is configured for electricity generation, and the driving of the electric vehicle is performed by the second electric motor 200. In this case, the controller 400 manages the energy conversion of the first electric motor 120, that is, during the operation of that first electric motor 120 driven by the engine 110, the electrical energy output from the first electric motor 120 is converted into direct current and stored to the battery, such that the first powertrain 100 operates in the electricity generation mode. The controller 400 managing the energy conversion of the second electric motor 200 includes: converting the electrical energy output from the battery into alternating current to drive the second electric motor 200 to operate, such that the second electric motor 200 operates in the third driving mode; and converting the alternating current generated by the second electric motor 200 into direct current to recharge the battery under conditions such as vehicle braking, such that the second electric motor 200 operates in the first energy recovery mode.

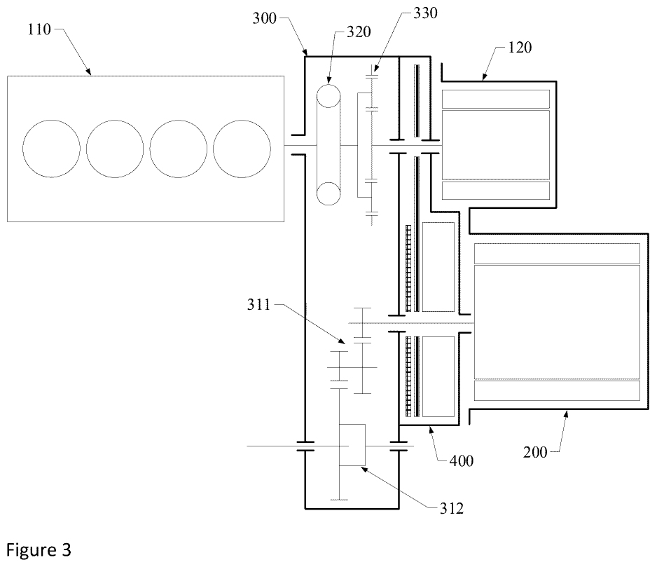

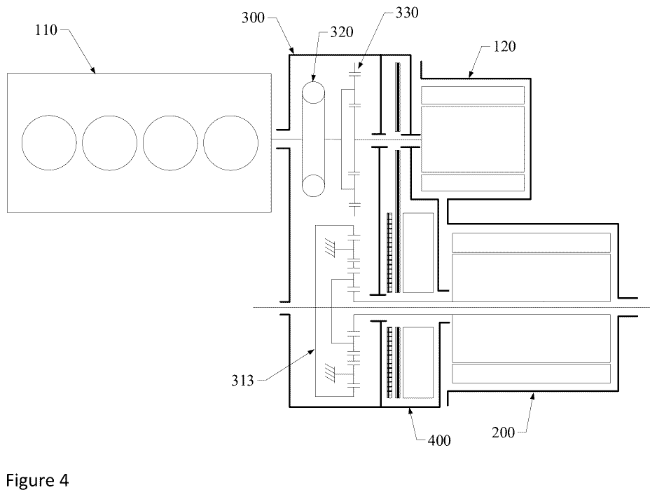

FIGS. 3 and 4 illustrate the structure of the powertrain assembly without any mechanical coupling between the first powertrain and the second electric motor. As shown in FIGS. 1, 3 and 4, when there is no mechanical coupling between the first powertrain 100 and the second electric motor 200, the engine 110 is connected to the first electric motor 120 via a transmission member to form the first powertrain 100 configured for electricity generation, and the second electric motor 200 configured for driving is connected to the differential mechanism 310.

As shown in FIGS. 1, 3 and 4, the transmission member connected between the engine 110 and the first electric motor 120 may include a torsional damper 320 and/or a planetary speed increaser 330, and the engine 110 may be connected to the first electric motor 120 via the torsional damper 320 and the planetary speed increaser 330 in sequence. The torsional damper 320 is configured to absorb the torsional vibration of the engine 110, allowing the engine 110 to output stable power. The planetary speed increaser 330 is configured to match the rotational speeds and torques of the engine 110 and the first electric motor 120 to optimize the operating efficiency. One possible way of assembly is as follows: the torsional damper 320 is connected at one end to an output shaft of the engine 110 and at the other end to a planetary carrier of the planetary speed increaser 330, a sun gear of the planetary speed increaser 330 is connected to an input shaft of the first electric motor 120, and a ring gear of the planetary speed increaser 330 is fixed. The planetary speed increaser 330 is configured to amplify the rotational speed of the engine 110 to meet the high-rotational speed requirements for electricity generation, thereby enabling efficient electricity generation and driving. Of course, the way of assembly of the torsional damper 320 and/or the planetary speed increaser 330 is not limited thereto, as long as effective transmission between the engine 110 and the first electric motor 120 can be achieved.

As shown in FIGS. 1 and 3, the differential mechanism 310 includes: a gear set 311 connected to the second electric motor 200; and a differential 312 connected to the gear set 311. The gear set 311 may be a conventional gear set and/or a planetary gear set, which can transmit power, alter the rotational speed and torque, enable reversing, etc. The differential 312 is configured to adjust the rotational speed difference between left and right wheels, transmit power smoothly, etc.

As shown in FIGS. 1 and 4, in some possible implementations, the differential mechanism 310 may be replaced with an integrated differential. Specifically, the differential mechanism 310 is composed of two differential planetary gear sets, forming a coaxial planetary speed reducer 313 integrated with a differential. The coaxial planetary speed reducer 313 integrated with a differential employing two differential planetary gear sets can achieve both speed reduction and differential functions, and has a compact structure. The specific arrangement of the coaxial planetary speed reducer 313 integrated with a differential may be as follows: power is input from a sun gear of a first planetary gear set structure, and output through a planetary carrier of the first planetary gear set structure to a wheel end on one side, a ring gear of the first planetary gear set structure is connected to a sun gear of a second planetary gear set structure, a planetary carrier of the second planetary gear set structure is fixed, and power is output through a ring gear of the second planetary gear set structure to a wheel end on the other side. The differential function of the coaxial planetary speed reducer 313 integrated with a differential is as follows: the planetary carrier and the ring gear of the first planetary gear set produce differential motion when the loads on the wheel ends on the two sides are different; and the planetary carrier of the second planetary gear set is fixed, and the rotational speed of the ring gear of the second planetary gear set is proportional to the rotational speed of the sun gear thereof, thereby achieving differential output at the wheel end on the other side. The speed reduction function of the coaxial planetary speed reducer 313 integrated with a differential is as follows: the output rotational speed of the planetary carrier of the first planetary gear set is lower than the input rotational speed of the sun gear thereof, achieving a first-stage speed reduction; and the output rotational speed of the ring gear of the second planetary gear set is lower than the input rotational speed of the sun gear thereof, achieving a second-stage speed reduction. In other embodiments, the two differential planetary gear sets may have other arrangements, as long as the speed reduction and differential functions can be achieved.

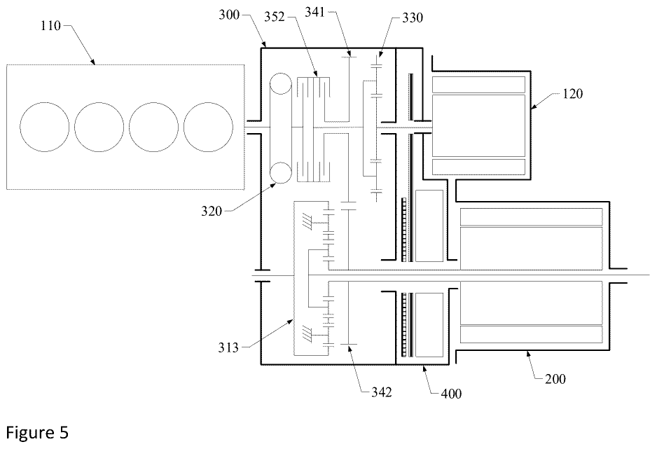

FIGS. 5, 6 and 7 illustrate the structure of the powertrain assembly with a mechanical coupling between the first powertrain and the second electric motor. As shown in FIG. 1 and FIGS. 5 to 7, in some embodiments, there is a mechanical coupling between the first powertrain 100 and the second electric motor 200, the first powertrain 100 is configured for electricity generation and driving, and the driving of the electric vehicle may be implemented by the first powertrain 100 and/or the second electric motor 200. In this case, the controller 400 managing the energy conversion of the first electric motor 120 includes: during the operation of that first electric motor 120 driven by the engine 110, the controller 400 converting the electrical energy output from the first electric motor 120 into direct current and storing it to the battery, such that the first powertrain 100 operates in the electricity generation mode; the controller 400 converting the electrical energy output from the battery into alternating current to drive the first electric motor 120 to operate, the power being transmitted to the differential mechanism 310 through a coupling component, and the first electric motor 120 operating in the second driving mode; and converting the electrical energy output from the first electric motor 120 into direct current for storage to the battery in the second energy recovery mode. The controller 400 managing the energy conversion of the second electric motor 200 includes: converting the electrical energy output from the battery into alternating current to drive the second electric motor 200 to operate, the power being transmitted to the differential mechanism 310, and the second electric motor 200 operating in the third driving mode; and the controller 400 converting the alternating current generated by the second electric motor 200 into direct current to charge back to the battery in the first energy recovery mode and the second energy recovery mode.

As shown in FIG. 1 and FIGS. 5 to 7, in some embodiments, the coupling component of the transmission device 300 for coupling the first powertrain 100 with the second electric motor 200 includes: a transmission gear including a first toothed member 341 connected to the first powertrain 100 and a second toothed member 342 connected to the second electric motor 200; and a clutch (351, 352) connected between the engine 110 and the first toothed member 341.

The transmission gear may be a conventional transmission gear or a planetary transmission gear, and the transmission gear may include other toothed members, not limited to the first toothed member 341 and the second toothed member 342. The mechanical coupling between the first powertrain 100 and the second electric motor 200 is achieved by the transmission gear. The coupling of the first powertrain 100 and the second electric motor 200, or the independent operation of the first powertrain 100 and the second electric motor 200, is achieved by the engagement and disengagement of the clutch (351, 352) as required by the operating conditions.

In some embodiments, when the transmission member connected between the engine 110 and the first electric motor 120 includes the torsional damper 320 and the planetary speed increaser 330, and a coupling component is provided between the first powertrain 100 and the second electric motor 200, the coupling component may be connected between the torsional damper 320 and the planetary speed increaser 330, in particular, the first toothed member 341 is connected between the torsional damper 320 and the planetary speed increaser 330 such that the first toothed member 341 can receive smooth power after the torsional vibration is absorbed by the torsional damper 320, without affecting the output of the power of the first electric motor 120 after the speed is reduced and the torque is increased by the planetary speed increaser 330 during driving. The transmission gear is preferably a speed reduction gear set which functions to transmit power with reduced speed and increased torque during the driving of the first powertrain 100.

In some embodiments, as shown in FIGS. 1, 6 and 7, the clutch is a single clutch 351. Two members of the single clutch 351 are respectively connected to the engine 110 and the first toothed member 341 (the first toothed member 341 may be disposed on a transmission shaft between the engine 110 and the first electric motor 120), and the two members of the single clutch 351 can be engaged with or disengaged from each other.

In the electricity generation mode, the two members of the single clutch 351 are engaged with each other, and the power of the engine 110 is transmitted to the first electric motor 120 through the torsional damper 320, the single clutch 351 and the planetary speed increaser 330 in sequence, and drives the first electric motor 120 to generate electricity, and the controller 400 performs energy conversion on the electrical energy output from the first electric motor 120 before it is stored to the battery. In the first driving mode, the two members of the single clutch 351 are engaged with each other, the power of the engine 110 is transmitted to the coaxial planetary speed reducer 313 integrated with a differential through the torsional damper 320, the single clutch 351, the first toothed member 341 and the second toothed member 342 in sequence, to drive the wheels. In the operating mode in which the electricity generation mode is executed simultaneously with the first driving mode, part of the power of the engine 110 is transmitted to the first electric motor 120 to drive the first electric motor 120 to generate electricity, and part of the power is transmitted to the coaxial planetary speed reducer 313 integrated with a differential to drive the wheels. In the second driving mode, the two members of the single clutch 351 are disengaged from each other, the controller 400 performs energy conversion on the electrical energy output from the battery to drive the first electric motor 120 to operate, and the power of the first electric motor 120 is transmitted to the coaxial planetary speed reducer 313 integrated with a differential through the planetary speed increaser 330 (at which point the planetary speed increaser 330 functions to reduce the speed and increase the torque), the first toothed member 341 and the second toothed member 342 in sequence, to drive the wheels. In the operating mode in which the first driving mode is executed simultaneously with the second driving mode, the two members of the single clutch 351 are engaged with each other, and the power of the engine 110 and the power of the first electric motor 120 are respectively transmitted to the first toothed member 341, and are collectively transmitted to the coaxial planetary speed reducer 313 integrated with a differential through the first toothed member 341 and the second toothed member 342, to drive the wheels. In the operating mode in which the first driving mode is executed simultaneously with the second driving mode, in order to achieve a smooth transmission of power, between the engine 110 and the first toothed member 341, and between the first electric motor 120 and the first toothed member 341, other power coupling components may also be provided, and/or the electronic control unit may be used to adjust the output of the engine 110 and the first electric motor 120 in real time to ensure the synchronization of the rotational speeds. In the third driving mode, the two members of the single clutch 351 are disengaged from each other, the controller 400 performs energy conversion on the electrical energy output from the battery to drive the second electric motor 200 to operate, and the power of the second electric motor 200 is transmitted to the coaxial planetary speed reducer 313 integrated with a differential, to drive the wheels. In the operating mode in which the third driving mode is executed simultaneously with the electricity generation mode, the two members of the single clutch 351 are engaged with each other, the power of the engine 110 is transmitted to the first electric motor 120 to drive the first electric motor 120 to generate electricity, and the power of the second electric motor 200 is transmitted to the coaxial planetary speed reducer 313 integrated with a differential, to drive the wheels. Under the operating condition where the third driving mode is executed simultaneously with the first driving mode, the two members of the single clutch 351 are engaged with each other, and the power of the engine 110 and the power of the second electric motor 200 are respectively transmitted to the coaxial planetary speed reducer 313 integrated with a differential, to collectively drive the wheels. In the operating mode in which the third driving mode is executed simultaneously with the second driving mode, the two members of the single clutch 351 are disengaged from each other, the power of the first electric motor 120 and the power of the second electric motor 200 are respectively transmitted to the coaxial planetary speed reducer 313 integrated with a differential, to collectively drive the wheels. In the operating mode in which the third driving mode is executed simultaneously with the electricity generation mode and the first driving mode, the two members of the single clutch 351 are engaged with each other, part of the power of the engine 110 is transmitted to the first electric motor 120 to drive the first electric motor 120 to generate electricity, and part of the power of the engine 110 and the power of the second electric motor 200 are respectively transmitted to the coaxial planetary speed reducer 313 integrated with a differential, to collectively drive the wheels. In the operating mode in which the third driving mode is executed simultaneously with the first driving mode and the second driving mode, the two members of the single clutch 351 are engaged with each other, the power of the engine 110 and the power of the first electric motor 120 are transmitted to the coaxial planetary speed reducer 313 integrated with a differential through the first toothed member 341 and the second toothed member 342, and the power of the second electric motor 200 is transmitted to the coaxial planetary speed reducer 313 integrated with a differential, to collectively drive the wheels. In the first energy recovery mode, the two members of the single clutch 351 are disengaged from each other, power from the coaxial planetary speed reducer 313 integrated with a differential drives the second electric motor 200 to rotate, and the controller 400 performs energy conversion on the electrical energy output from the second electric motor 200 before it is stored to the battery. In the operating mode in which the first energy recovery mode is executed simultaneously with the electricity generation mode, the two members of the single clutch 351 are engaged with each other, the power from the coaxial planetary speed reducer 313 integrated with a differential drives the second electric motor 200 to rotate, the power of the engine 110 drives the first electric motor 120 to operate, and the controller 400 performs energy conversion on the electrical energy output from the first electric motor 120 and the second electric motor 200 before it is stored to the battery. In the second energy recovery mode, the two members of the single clutch 351 are disengaged from each other, the power from the coaxial planetary speed reducer 313 integrated with a differential drives the second electric motor 200 and the first electric motor 120 to rotate, and the controller 400 performs energy conversion on the electrical energy output from the first electric motor 120 and the second electric motor 200 before it is stored to the battery. In the operating mode in which the second energy recovery mode is executed simultaneously with the electricity generation mode, the two members of the single clutch 351 are engaged with each other, part of the power from the coaxial planetary speed reducer 313 integrated with a differential drives the second electric motor 200 to rotate, part of the power from the coaxial planetary speed reducer 313 integrated with a differential and the power of the engine 110 collectively act on the first electric motor 120, to drive the first electric motor 120 to generate electricity, and the controller 400 performs energy conversion on the electrical energy output from the first electric motor 120 and the second electric motor 200 before it is stored to the battery. The components of the transmission device 300 may be connected by suitable methods or techniques such as meshing, shaft coupling, etc. Each operating mode can be configured as required.

In some embodiments, the transmission device 300 further includes: a planetary gear shift mechanism connected between the second toothed member 342 and the differential mechanism 310. The planetary gear shift mechanism enables gear ratio adjustment.

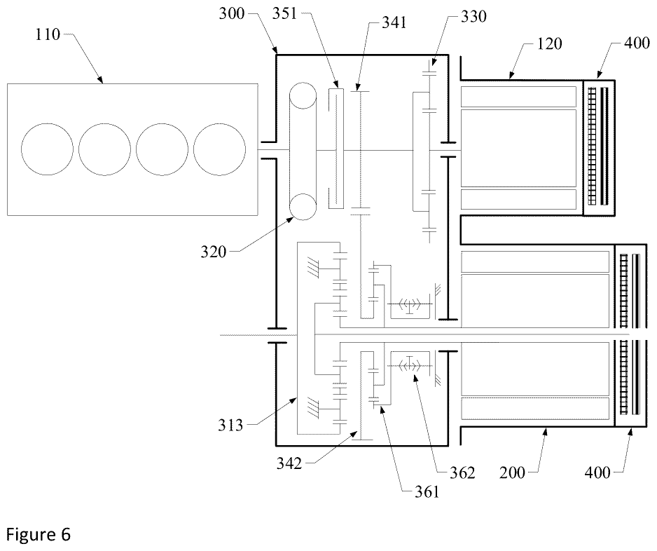

Referring to FIG. 6, the planetary gear set shift mechanism may specifically include: a planetary gear mechanism 361 including three transmission elements, where a first transmission element (e.g., a sun gear) is connected to the second toothed member 342, and a second transmission element (e.g., a planetary carrier) is connected to the coaxial planetary speed reducer 313 integrated with a differential; and a synchronizer 362 configured to fix the second transmission element to a third transmission element (e.g., a ring gear) of the planetary gear mechanism 361, to free the three transmission elements of the planetary gear mechanism 361, or to fix the third transmission element. In this way, gear shifting is implemented by the movement of the synchronizer 362 changing the transmission mode between the three transmission elements of the planetary gear mechanism 361, that is, changing the transmission ratio of the planetary gear mechanism 361. In other embodiments, the planetary gear shift mechanism may have other arrangements, and is not limited to that shown in FIG. 6.

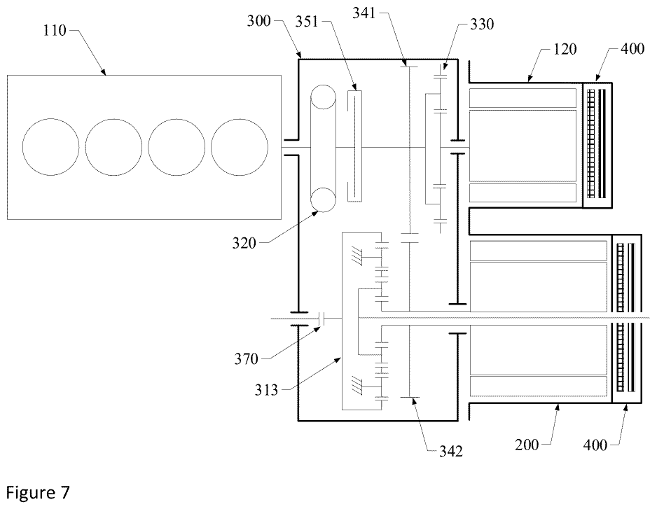

Referring to FIG. 7, in some embodiments, the transmission device 300 further includes: a disengagement mechanism 370 disposed on an output shaft of the differential mechanism (which is specifically the coaxial planetary speed reducer 313 integrated with a differential in FIG. 7). The disengagement mechanism 370 is configured to cut off power transmission as required, to meet the requirements of specific operating conditions. The disengagement mechanism 370 may be formed as a clutch type or as a sliding sleeve type.

In some embodiments, as shown in FIGS. 1 and 5, the clutch is a dual clutch 352. The dual clutch 352 has a first member connected to the engine 110, a second member connected to the first electric motor 120, and a third member connected to the first toothed member 341. The first member and the third member can each be engaged with or disengaged from the second member, and the first member can be engaged with or disengaged from the third member. One possible arrangement of the dual clutch 352 is as follows: the second member is disposed between the first member and the third member, all three members are located within a housing of the dual clutch 352, the first member may be in a free state or may be moved to engage with the housing or the second member, and the third member may be in a free state or may be moved to engage with the housing or the second member.

In the electricity generation mode, the first member and the second member of the dual clutch 352 are engaged with each other, and the power of the engine 110 is transmitted to the first electric motor 120 through the torsional damper 320, the dual clutch 352 and the planetary speed increaser 330 in sequence, and drives the first electric motor 120 to generate electricity, and the controller 400 performs energy conversion on the electrical energy output from the first electric motor 120 before it is stored to the battery. In the first driving mode, the first member and the third member of the dual clutch 352 are engaged with each other, the power of the engine 110 is transmitted to the coaxial planetary speed reducer 313 integrated with a differential through the torsional damper 320, the dual clutch 352, the first toothed member 341 and the second toothed member 342 in sequence, to drive the wheels. In the operating mode in which the electricity generation mode is executed simultaneously with the first driving mode, the first member, the second member and the third member of the dual clutch 352 are engaged with each other, part of the power of the engine 110 is transmitted to the first electric motor 120 to drive the first electric motor 120 to generate electricity, and part of the power is transmitted to the coaxial planetary speed reducer 313 integrated with a differential to drive the wheels. In the second driving mode, the third member and the second member of the dual clutch 352 are engaged with each other, the controller 400 performs energy conversion on the electrical energy output from the battery to drive the first electric motor 120 to operate, and the power of the first electric motor 120 is transmitted to the coaxial planetary speed reducer 313 integrated with a differential through the planetary speed increaser 330 (at which point the planetary speed increaser 330 functions to reduce the speed and increase the torque), the dual clutch 352, the first toothed member 341 and the second toothed member 342 in sequence, to drive the wheels. In the operating mode in which the first driving mode is executed simultaneously with the second driving mode, the three members of the dual clutch 352 are engaged with each other, and the power of the engine 110 and the power of the first electric motor 120 are respectively transmitted to the dual clutch 352, and are collectively transmitted to the coaxial planetary speed reducer 313 integrated with a differential through the first toothed member 341 and the second toothed member 342, to drive the wheels. In the third driving mode, the three members of the dual clutch 352 are disengaged from each other, the controller 400 performs energy conversion on the electrical energy output from the battery to drive the second electric motor 200 to operate, and the power of the second electric motor 200 is transmitted to the coaxial planetary speed reducer 313 integrated with a differential, to drive the wheels. In the operating mode in which the third driving mode is executed simultaneously with the electricity generation mode, the first member and the second member of the dual clutch 352 are engaged with each other, the power of the engine 110 is transmitted to the first electric motor 120 to drive the first electric motor 120 to generate electricity, and the power of the second electric motor 200 is transmitted to the coaxial planetary speed reducer 313 integrated with a differential, to drive the wheels. Under the operating condition where the third driving mode is executed simultaneously with the first driving mode, the first member and the third member of the dual clutch 352 are engaged with each other, and the power of the engine 110 and the power of the second electric motor 200 are respectively transmitted to the coaxial planetary speed reducer 313 integrated with a differential, to collectively drive the wheels. In the operating mode in which the third driving mode is executed simultaneously with the second driving mode, the third member and the second member of the dual clutch 352 are engaged with each other, the power of the first electric motor 120 and the power of the second electric motor 200 are respectively transmitted to the coaxial planetary speed reducer 313 integrated with a differential, to collectively drive the wheels. In the operating mode in which the third driving mode is executed simultaneously with the electricity generation mode and the first driving mode, the first member and the second member of the dual clutch 352 are engaged with each other, part of the power of the engine 110 is transmitted to the first electric motor 120 to drive the first electric motor 120 to generate electricity, and part of the power of the engine 110 and the power of the second electric motor 200 are respectively transmitted to the coaxial planetary speed reducer 313 integrated with a differential, to collectively drive the wheels. In the operating mode in which the third driving mode is executed simultaneously with the first driving mode and the second driving mode, the three members of the dual clutch 352 are engaged with each other, the power of the engine 110 and the power of the first electric motor 120 are transmitted to the coaxial planetary speed reducer 313 integrated with a differential through the dual clutch 352, the first toothed member 341 and the second toothed member 342, and the power of the second electric motor 200 is transmitted to the coaxial planetary speed reducer 313 integrated with a differential, to collectively drive the wheels. In the first energy recovery mode, the three members of the dual clutch 352 are disengaged from each other, power from the coaxial planetary speed reducer 313 integrated with a differential drives the second electric motor 200 to rotate, and the controller 400 performs energy conversion on the electrical energy output from the second electric motor 200 before it is stored to the battery. In the operating mode in which the first energy recovery mode is executed simultaneously with the electricity generation mode, the first member and the second member of the dual clutch 352 are engaged with each other, the power from the coaxial planetary speed reducer 313 integrated with a differential drives the second electric motor 200 to rotate, the power of the engine 110 drives the first electric motor 120 to operate, and the controller 400 performs energy conversion on the electrical energy output from the first electric motor 120 and the second electric motor 200 before it is stored to the battery. In the second energy recovery mode, the third member and the second member of the dual clutch 352 are engaged with each other, the power from the coaxial planetary speed reducer 313 integrated with a differential drives the second electric motor 200 to rotate, and drives the first electric motor 120 to rotate through the second toothed member 342, the first toothed member 341, the dual clutch 352 and the planetary speed increaser 330, and the controller 400 performs energy conversion on the electrical energy output from the first electric motor 120 and the second electric motor 200 before it is stored to the battery. In the operating mode in which the second energy recovery mode is executed simultaneously with the electricity generation mode, the three members of the dual clutch 352 are engaged with each other, part of the power from the coaxial planetary speed reducer 313 integrated with a differential drives the second electric motor 200 to rotate, part of the power from the coaxial planetary speed reducer 313 integrated with a differential and the power of the engine 110 are respectively transmitted to the dual clutch 352 and collectively act on the first electric motor 120 through the planetary speed increaser 330, to drive the first electric motor 120 to generate electricity, and the controller 400 performs energy conversion on the electrical energy output from the first electric motor 120 and the second electric motor 200 before it is stored to the battery. The components of the transmission device 300 may be connected by suitable methods or techniques such as meshing, shaft coupling, etc. Each operating mode can be configured as required.

The above is a further detailed description of the present disclosure with reference to the specific preferred implementations, and it cannot be considered that the specific implementation of the present disclosure is limited to these descriptions. For those of ordinary skill in the art of the present disclosure, several simple deductions or substitutions can be further made without departing from the concept of the present disclosure, and should be regarded as falling within the scope of protection of the present disclosure.

1. A powertrain assembly for an electric vehicle, the powertrain assembly comprising:
an engine;
a first electric motor;
a second electric motor; and
a transmission device,
wherein the engine is connected to the first electric motor via part of members of the transmission device to form a first powertrain,
wherein the second electric motor is connected to a differential mechanism of the transmission device, and
wherein the powertrain assembly further comprises a controller shared by the first electric motor and the second electric motor, wherein the controller is configured to manage energy conversion of the first electric motor and the second electric motor such that the first powertrain and/or the second electric motor operates in a specified operating mode.

2. The powertrain assembly of claim 1,
wherein the controller is configured to integrate at least two inverter modules that are respectively connected to the first electric motor and the second electric motor.

3. The powertrain assembly of claim 2,
wherein each of the at least two inverter modules comprises an inverter circuit and a drive circuit that are electrically connected to each other, wherein each inverter circuit is integrated on a power board of the controller, and each drive circuit is integrated on a control board of the controller.

4. The powertrain assembly of claim 3,
wherein the control board and the power board are assembled via a frame board and are electrically connected via a signal pin, and
wherein the signal pin passes through the frame board, and two ends of the signal pin are respectively electrically connected to the power board and the control board.

5. The powertrain assembly of claim 2,
wherein the controller is further provided with a heat dissipation module that acts on at least the at least two inverter modules.

6. The powertrain assembly of claim 2,
wherein the controller is further provided with a capacitor shared by the at least two inverter modules.

7. The powertrain assembly of claim 6,
wherein the capacitor is integrally potted with an enclosure of the controller, or the capacitor is packaged by a housing separate from the enclosure of the controller.

8. The powertrain assembly of claim 1,
wherein there is no mechanical coupling between the first powertrain and the second electric motor, and the first powertrain is configured for electricity generation.

9. The powertrain assembly of claim 1,
wherein there is a mechanical coupling between the first powertrain and the second electric motor, and the first powertrain is configured for electricity generation and driving.

10. The powertrain assembly of claim 9, comprising:
a coupling component of the transmission device configured to couple the first powertrain with the second electric motor, wherein the coupling component comprises:
a transmission gear comprising a first toothed member connected to the first powertrain and a second toothed member connected to the second electric motor; and
a clutch connected between the engine and the first toothed member.

11. The powertrain assembly of claim 10,
wherein the clutch is a single clutch having two members respectively connected to the engine and the first toothed member, the two members of the single clutch being engageable with or disengageable from each other.

12. The powertrain assembly of claim 10,
wherein the clutch is a dual clutch having a first member connected to the engine, a second member connected to the first electric motor, and a third member connected to the first toothed member, and
wherein the first member and the third member are each engageable with or disengageable from the second member, and the first member is engageable with or disengageable from the third member.

13. The powertrain assembly of claim 10,
wherein the transmission device further comprises:
a planetary gear shift mechanism connected between the second toothed member and the differential mechanism.

14. The powertrain assembly of claim 13,
wherein the planetary gear shift mechanism comprises:
a planetary gear mechanism comprising three transmission elements, wherein a first transmission element is connected to the second toothed member, and a second transmission element is connected to the differential mechanism; and
a synchronizer configured to fix the second transmission element to a third transmission element of the planetary gear mechanism, to free all three transmission elements, or to fix the third transmission element.

15. The powertrain assembly of claim 1,
wherein the transmission device further comprises:
a disengagement mechanism disposed on an output shaft of the differential mechanism.

16. The powertrain assembly of claim 1,
wherein a transmission member connected between the engine and the first electric motor comprises a torsional damper and/or a planetary speed increaser.

17. The powertrain assembly of claim 16,
wherein when the transmission member comprises the torsional damper and the planetary speed increaser, and wherein a coupling component is provided between the first powertrain and the second electric motor, and
wherein the coupling component is connected between the torsional damper and the planetary speed increaser.

18. The powertrain assembly of claim 1,
wherein the differential mechanism comprises:
a gear set connected to the second electric motor; and
a differential connected to the gear set.

19. The powertrain assembly of claim 1,
wherein the differential mechanism comprises two differential planetary gear sets forming a coaxial planetary speed reducer integrated with a differential.

20. The powertrain assembly of claim 1,
wherein the powertrain assembly is operable in any of the following operating modes:
the first powertrain operating in an electricity generation mode when the engine drives the first electric motor by the transmission device;
a first driving mode in which the engine operates when the engine drives the differential mechanism by the transmission device;
a second driving mode in which the first electric motor operates when the first electric motor drives the differential mechanism by the transmission device;
an operating mode in which the electricity generation mode is executed simultaneously with the first driving mode;
an operating mode in which the first driving mode is executed simultaneously with the second driving mode;
a third driving mode in which the second electric motor operates when the second electric motor drives the differential mechanism;
an operating mode in which the third driving mode is executed simultaneously with the electricity generation mode;
an operating mode in which the third driving mode is executed simultaneously with the first driving mode;
an operating mode in which the third driving mode is executed simultaneously with the second driving mode;
an operating mode in which the third driving mode is executed simultaneously with the electricity generation mode and the first driving mode;
an operating mode in which the third driving mode is executed simultaneously with the first driving mode and the second driving mode;
a first energy recovery mode in which the second electric motor operates when the second electric motor recovers energy;
an operating mode in which the first energy recovery mode is executed simultaneously with the electricity generation mode;
a second energy recovery mode in which the first electric motor and the second electric motor operate when the first electric motor and the second electric motor collectively recover energy; and/or
an operating mode in which the second energy recovery mode is executed simultaneously with the electricity generation mode.
